(19) United States
(12) Patent Application Publication
(10) Pub. No.: US 2019/0004932 A1
(43) Pub. Date: Jan. 3, 2019

(54) UNIT TEST AND AUTOMATION FRAMEWORK (UTAF) SYSTEM AND METHOD

(71) Applicant: Infinera Corporation, Sunnyvale, CA (US)

(72) Inventors: Mohit Misra, Bangalore (IN); Subhendu Chattopadhyay, Bangalore (IN); Ravi Shankar Pandey, Bangalore (IN); Saurabh Pandey, Uttarakhand (IN); Ruchi Agrawal, Indore (IN)

(73) Assignee: Infinera Corporation, Sunnyvale, CA (US)

(21) Appl. No.: 15/640,115

(22) Filed: Jun. 30, 2017

(51) Int. Cl. G06F 11/36

(52) U.S. Cl. CPC G06F 11/3664; G06F 11/3692; G06F 11/3688

(57) ABSTRACT

A unit test and automation framework (UTAF) system and method are disclosed for unit testing. A unit definition file that includes properties of the unit being tested may be compiled to generate a skeleton code that describes a structure of the unit and the interactions of the unit with other units. One or more interactions may be overridden to generate a unit production code for the unit. A unit testing (UT) engine may enable interactions between the unit and the other units to run test cases on the unit production code as part of unit testing. Various components of the UTAF system may provide commands to or perform functions for the UT engine to perform the unit testing, such as providing test commands, displaying statistics, providing interface messaging between the unit and the plurality of other units, provide commands for record and replay testing, and other information.

### FIELD OF INVENTION

The disclosure relates generally to testing software systems and more particularly to a unit test and automation framework system and method.

### BACKGROUND

Test automation software may be developed for effective software testing, whereby repetitive tasks may be automated in a formalized testing process and other tasks, which may be difficult to do manually, may be performed. A test automation framework may be an integrated system that sets the rules and combines approaches for automation of a particular software product or products in an effort to simplify automation testing. For example, a test automation framework may integrate function libraries, test data sources, object details and/or various reusable modules and other building blocks which form a process (i.e., a process is an instance of a computer program being executed and may be made up of multiple threads of execution that execute instructions concurrently). A test automation framework may provide the basis of test automation, and may reduce the cost of testing and maintenance. For example, if there is change to any test case then only the test case file may be updated and the driver script and startup script may remain the same.

A growing trend in software development is the use of testing frameworks that allow the execution of unit tests, wherein individual units of the software or sections of the code are tested separately using appropriate test cases to verify that each unit performs as expected. A unit of software may be considered the smallest testable part of software, and may have one or more inputs and one or more expected outputs. For example, a unit of software may be, but is not limited to the following: a program; a function; a method; a class; an application module; and/or procedure. Unit testing may be particularly efficient and effective when a piece of code is being modified or changed, because it permits the testing and removal of defects in the modified code prior to introducing it into the integrated software system. A limitation of existing unit testing frameworks is that input and output signals are manually generated, which is generally a costly and time-consuming task that is unable to properly record the complexity of all possible events.

Another software testing framework technique is regression testing, which verifies that software that was previously developed and tested still performs correctly when the software is modified or interfaced with other software. Examples of software changes include, but are not limited to: software enhancements; software upgrades; software patches; and/or configuration changes. During regression testing, new software bugs or regressions may be uncovered, and may thus be corrected before releasing a new version of the software. Regression testing may be performed to test a system efficiently by systematically selecting the appropriate minimum set of tests needed to adequately cover a particular change and may involve rerunning previously completed tests and checking whether program behavior has changed and whether previously fixed faults have re-emerged.

Software testing may employ record and replay (i.e., record and playback) techniques that allow users to interactively record user actions and replay them back any number of times during testing. For example, record and replay testing may be an effective tool during regression testing to verify that any changes made to any portion (e.g., unit) of software results in the desired outcome. Record and replay testing may work with any type of software application with an output interface, such that the actual results generated during testing may be compared with the expected results to detect errors or bugs.

### SUMMARY

A unit test and automation framework (UTAF) system and method are disclosed for unit testing. A unit definition file that includes properties of the unit being tested may be compiled to generate a skeleton code that describes a structure of the unit and the interactions of the unit with other units. One or more interactions may be overridden to generate a unit production code for the unit. A unit testing (UT) engine may enable interactions between the unit and the other units to run test cases on the unit production code as part of unit testing. Various components of the UTAF system may provide commands to or perform functions for the UT engine to perform the unit testing, such as providing test commands, displaying statistics, providing interface messaging between the unit and the plurality of other units, provide commands for record and replay testing, and other information. the skeleton code may automatically instantiate stubs for the other units that interact with the unit during run-time operation. The skeleton code may automatically generate sample automation scripts for each application programming interface (API) exposed by the unit during run-time operation. The skeleton code may include application programming interfaces (APIs) for the plurality of other units, CLI handlers, a system state machine (SSM) handler, an automation handler, an IPC handler, and/or stubs for the plurality of other units.

### BRIEF DESCRIPTION OF THE DRAWINGS

FIG. 1 is a high-level system diagram of an example UTAF system 100, in accordance with the disclosures herein;

FIG. 2 is a high-level system diagram of an example unit code generation system for generating unit code for the complete unit being tested from the unit definition file, in accordance with the disclosures herein;

FIG. 3 is a flow diagram of a UTAF procedure, in accordance with the disclosures herein; and

FIG. 4 is a block diagram of a computing system in which one or more disclosed embodiments may be implemented.

### DETAILED DESCRIPTION OF THE EMBODIMENTS

The disclosed unit test and automation framework (UTAF) system and method, for the purpose of testing a software unit (module), describe properties of the unit in a text file, which may be referred to as the unit or module definition file. Examples of unit properties that may be included in the unit definition file include, but are not limited to, the following properties: unit name; the application programming interfaces (APIs) offered by the unit; the unit's dependencies on other units such as inter-process communications (IPCs) or APIs imported from other units; and/or expected states of other units. The disclosed UTAF system uses the unit definition file as an interface control document for the unit. The unit definition file provides a programmer with easy access to information about dependencies of the unit with other units in the system because it is not buried inside the code of the unit. Additionally, it provides the programmer with control because a unit may not change its interfaces during testing unless its unit definition file is changed.

The unit definition file may have a structured format that is designed to enable the generation of code (e.g., C++ code) to build a skeleton code of the unit that automatically instantiates stubs for the other units that interact with the unit being tested during normal run-time operation (a stub simulates the behavior of a called unit that is called by the unit being tested during run-time operation). The skeleton code simulates the processing of the unit code thus enabling parsing, compilation and testing of the unit code. The skeleton code is then used to simulate the unit running in standalone mode and the expected behavior of the other units during run-time as part of unit testing in a UTAF system.

The disclosed UTAF system and method may provide library functions to help in the unit automation of the unit being tested. Compiling the unit definition file generates sample automation scripts for each API/function exposed by the unit being tested. The programmer can then edit values of various parameters being passed to a function (e.g., an exported API) and invoke the function by running the script. The UTAF system and method may automatically assert on the expected return value described in the script versus what is returned by the function during the script execution. While the disclosed UTAF system and methods are described herein for testing C++ code, it is understood by one skilled in the art that the disclosed UTAF system and methods may be similarly used to test software modules (equivalently applications, units, functions, programs, etc.), written in any other programming language (e.g., java, python, etc.).

Several tools may be used in unit testing that provide the ability to declare test cases in the code being tested and provide macros (i.e., a predefined sequence of computing instructions that can be reused), for example, to call functions independently, check values of data structures, be used as assert mechanisms, and run test suites, among other things. Such testing tools may involve changes to the code being tested. Also, such testing tools may need developers to write additional code for testing, which add considerably more effort during the software development cycle.

For example, in the case of unit testing of an application module, additional software pieces may be required to be developed by the programmer, requiring additional effort, including, but not limited to, one or more drivers, and stubs. A driver is a piece of code that calls the application programming interfaces (APIs) offered by the application module being tested, such that the driver simulates a calling unit (piece of code) and the stub simulates a called unit. The caller (i.e., driver) asserts the output of the called API based on the expected or desired behavior (an assertion is a statement that a predicate, such as a Boolean-valued function/true-false expression, is expected to always be true for the output or point in the code; if the assertion evaluates to false at run time, an assertion failure results, which may causes the program to crash or throw an assertion exception). The driver code calls the API for various combinations of valid/invalid input values in order to assert the correct expected value. A function stub is a piece of code that serves as controllable replacement for an existing dependency or programming functionality, and may be used to stand in for other APIs or functions which are called into other modules by the application module being tested. Stubs are developed separately but are not necessarily fully implemented. These function stubs should return values expected by the caller in a particular state or based on input values.

There are several conventional tools available for unit testing. For example, for testing code written in the C++ programming language, existing unit testing tools include the Boost test library, CPUnit, and Google Test. However, existing unit testing tools such as those mentioned solve only a portion of the problems of unit testing. For example, existing unit testing tools help in developing drivers and stubs, for example by using C++ (or other programming language) macros. However, existing unit testing tools do not provide support for identifying and maintaining interfaces offered or used by an application module being tested on a structured basis. For example, existing unit testing tools do not recognize the concept of a unit and its interface definitions and thus is not able to capture all input/output aspects of the unit. For example, a C++ class (i.e., a user defined type or data structure including data and methods (functions) as its members and whose access may be specified as private, protected or public) can indicate the APIs it offers by making those methods public. A unit may consist of several such classes with each class exporting some methods. An exported method of a class may be used by another class for internal purposes without generating an API of the unit or for the purpose of exposing an interface outside of the unit.

Existing unit testing tools do not provide support for instantiating stubs automatically at run-time during the unit testing in order to be able to bring up the application module being tested in stand-alone mode (i.e., tested independently from modules and functions that it normally interfaces with). Existing unit testing tools also are not designed to maintain the code in the application module being tested the same in standalone mode as when the module is running as part of its original system; that is, changes are made to the code of the module being tested. Furthermore, existing unit testing tools do not automatically generate unit testing scripts to aid in automation testing.

In some embedded software development environments, application modules may be tested along with system integration with no independent visibility or access to unit and functions within the system. In fact, in some complex, distributed software system with several interdependent modules working together, isolating a particular module for unit testing may be very challenging. For example, a module may be dependent on the states of several other modules and thus expects certain output from the function calls it makes to those other modules.

Thus, particularly for complex software system, in order to bring up a module for stand-alone unit testing, a programmer may analyze all the dependencies with other modules, develop extra code to mimic the states of other modules correctly and write stub code to return expected values for the function it calls to other modules. In many cases, the effort to develop code for generating stubs for other units/modules may be significantly more than developing the code for the unit being tested itself. Because of the amount of overhead involved in manually generated unit testing, a programmer may instead test a module by integrating with the complete system, necessitating that all system modules are available and stable during the testing, which may not be the case. Moreover, testing module functionality at the system level may not cover all the boundary conditions of the module and may provide poor test coverage.

As described above, there are many challenges to performing unit testing at the module level. The challenges include the rigorous task of determining all dependencies, such as states, function calls, and inter-process communications (IPCs), of the module being tested with all other modules in the system. This information may be buried deep in the code such that a programmer may go through the whole code to generate all dependencies.

Once the dependencies are identified, another challenge involves developing the code to stub out the dependencies so that a module can run independently as it would run in real system. Stub development is very challenging because the programmer needs to develop code to identify and return the correct expected values for the functions being called from the module being tested.

Moreover, an important advantage of unit testing is automation. At the unit test level, each function or API which the module offers to other layers should be tested for proper input and output values. Thus, the programmer writes additional code to call these APIs with different sets of input values and asserts the expected output of the functions, which is also a challenging and time consuming task. Thus, the disclosed UTAF system and method, described in further detail below, address these problems and deficiencies with existing unit testing solutions.

A software system may be made of several sub-systems or modules to provides services to the outside world. Each module may provide a unique service within the system in order to realize the system level services. The sub-systems (modules) may be made up of one or more units, where a unit may be considered a logical collection of classes and/or code that is small in size but complex enough to warrant its own testing (i.e., broken down as much as possible within the context of testability). For example, a unit may include a logical set of data structures and associated processing functions to provide a unique service to a sub-system, and may or may not be associated with a process or thread. A unit may be associated with a unique name or identifier (ID).

A unit has well-defined boundaries or interfaces to interact with other units in the system. For example, the boundaries could be message based, API based or socket based. It is at these boundaries or interfaces that a unit provides services to other units in the system. The disclosed UTAF system and method enforces consistent, identifiable external interface types (e.g., messaged based, functions calls, socket based, etc.) and automatically captures and prints/logs messages and calls at these interfaces. Classes and/or data structures are defined for the unit to maintain the state of the unit, and may be internal to the unit and inaccessible to neighboring units. For examples, classes may contain data, heaps, maps, queues, linked lists, and variables, among other things. In some cases, internal data structures are shared with other units and thus become an interface to the other units (no longer internal).

Inputs may be described as events or triggers to change data structure(s) within the unit, and may be internal or external to the unit. Examples of inputs include, but are not limited to, the following inputs: a message from a neighboring unit; a function call into the unit by a neighboring unit; expiry of a timer; and/or the reception of a packet. Processing performed by the unit may be described as manipulation routines (e.g., business logic) on the data structures based on reception of an input event. Outputs may be described as the outcome of the processing of an input event by the unit. For example, the output may be a desired change in the data structure, sending a message to another unit, a function call to a neighboring unit, a file input/output (IO), and/or the output of a packet, among other things. The output may drive the input of another unit or provide a required service in the overall system.

As described above, goals of unit testing include isolate a smallest piece of testable software in an application or software system from the remainder of the code, and determine whether it behaves exactly as per design expectations. Each unit may be tested separately before integrating the units into modules to test the interfaces between modules. Unit testing allows for automation of the testing process, reduces difficulties of discovering errors contained in more complex pieces of an application, and enhances test coverage because attention is given to each unit. A limitation of known approaches for unit testing is that they require drivers and stubs to be written by a programmer, which is both time and effort intensive, and prone to human error.

Challenges exist with unit testing, which lack standard tools that are available on different development and target platforms. For example, the unit itself, as well as the interfaces of the unit, may be hard to define because of the complex interaction of code in a system, and thus make it hard to isolate the unit and figure out what needs to be stubbed and what exported APIs should be tested for possible combinations, for example. In another example, it may be complex to code unit test cases for most or all combinations of input/outputs at the API level along with various states of the unit. In some cases, the unit testing code could be much bigger than the actual code being tested. Programmers also experience pressure for early integration and release of software, thus discouraging a long testing process that may be required to test all the units with manual coding of drivers and stubs, for example.

Thus, to improve upon existing unit testing systems and methods, the disclosed UTAF system and method enforce consistent definition and identification of a unit in a subsystem. The disclosed UTAF system and method enforce consistent, identifiable external interface types (e.g., message based, function calls, sockets calls, etc.), between units and provides automatic capture and logging of messages/calls. The disclosed UTAF system and method enable automatic bring up of a standalone unit by stubbing out dependencies on other units. The disclosed UTAF system and method enforce consistent, automated and fully defined command line interfaces in a unit to trigger input events and dump output in a standard format. The disclosed UTAF system and method integrate utilities to perform unit level testing of at least the following data and behaviors: unit input/output verification; actor/queue sizes and behavior; timer expiry events; thread execution/race conditions; memory leaks/corruption; and/or code coverage. The disclosed UTAF system and method also provides hooks for automation, external interface document generation, and improved speed and performance during setup and running of unit tests.

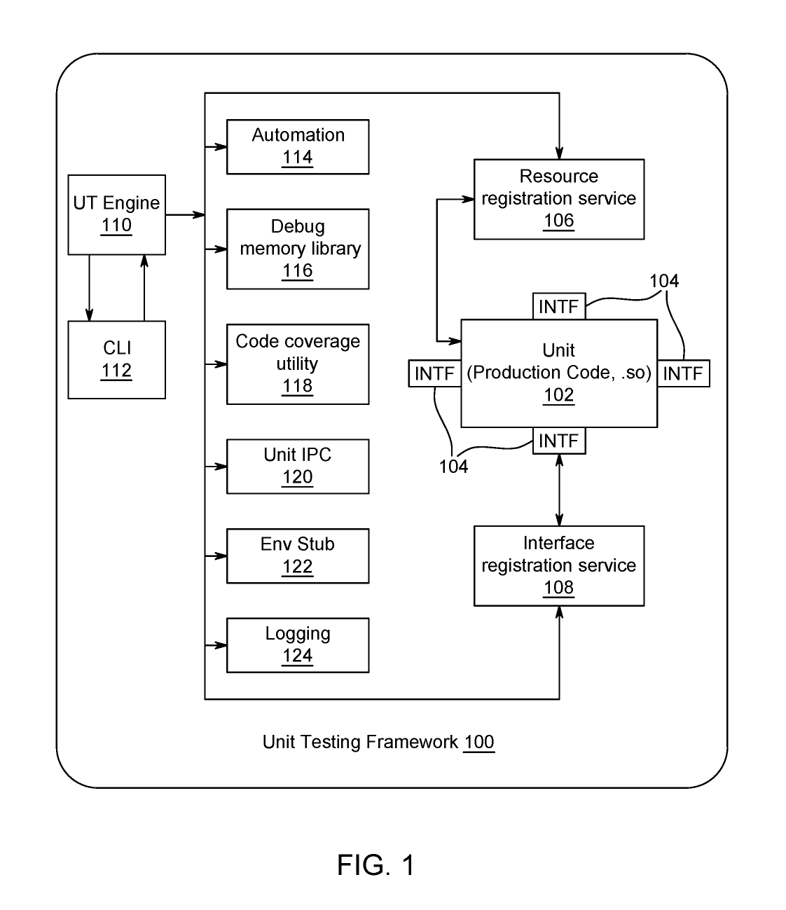

FIG. 1 is a high-level system diagram of an example UTAF system 100, in accordance with the disclosures herein. The example UTAF system 100 may include, but is not limited to include, any combination of the following components: the unit 102 (e.g., .so file) containing the production code for the unit 102 being tested, including all the interfaces 104 of the unit 102 being tested; resource registration service 106; interface registration service 108; unit test (UT) engine 110; command line interface (CLI) 112; automation component 114; debug memory library 116; code coverage utility component 118; unit IPC 120; environment stubbing component 122; and/or a logging component 124.

The UT engine 110 is a core component of the UTAF system 100 and is responsible for hosting the unit 102 in the UTAF system 100 to perform unit testing. In an example, a single instance of a UT engine 110 may be used per operating system (OS) process, (generally, one or more than one UT engine 110 may be used). When a unit 102 is instantiated in the UTAF system 100 for unit testing (e.g., by generating unit 102 production code), the unit 102 may register itself with the UT engine 110 via the interface registration service 108. The registration causes the UT engine 110 to know the presence of the unit 102 in the UTAF system 100 along with its interfaces with other units (usually represented by stubs in the unit testing environment/UTAF system 100). The registration mechanism may be the same whether the unit 102 being tested is operating in standalone mode or as part of the original complete system. As a result, the UT engine 110 knows what APIs are being offered by the unit 102 and also other APIs on which the unit 102 is dependent on. In order to bring up the unit 102 in standalone mode within the UTAF system 100, stub units, for other units that interact with unit 102, may also be instantiated and registered with the UT engine 110 to satisfy run time dependencies of the unit 102 being tested, thus facilitating communication among the unit 102 via message passing and/or API calls, with other stub units allowing the UT engine 110 to track all communications between the units and provide record and replay of messages for testing automation purposes, for example via automation component 114.

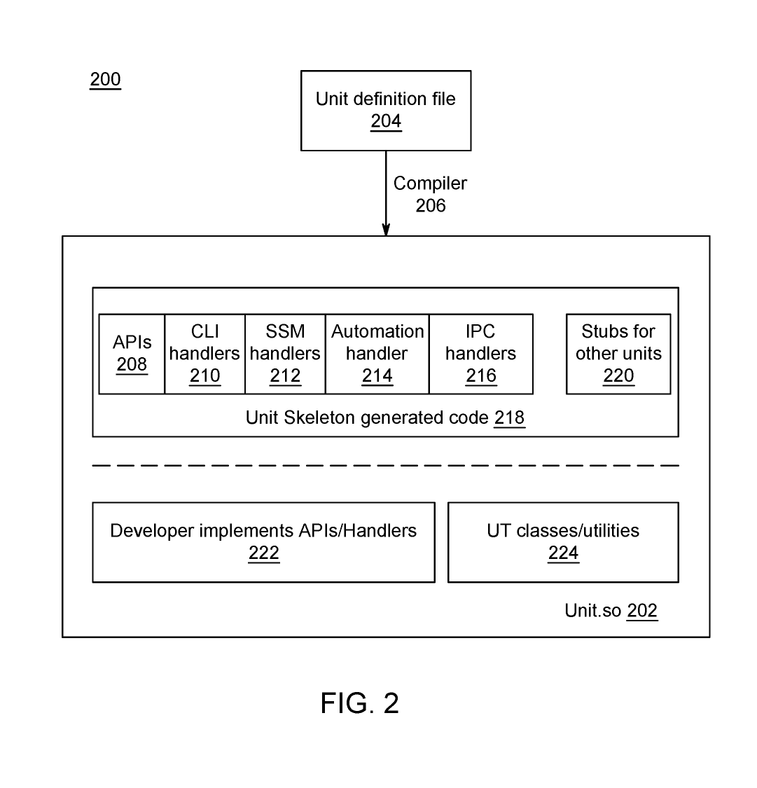

The skeleton code of a unit 102 is generated upon compilation of a definition file (described below with reference to FIG. 2). In an example for a unit written in C++, the generated C++ skeleton code of the unit 102 contains the base class (the base class may be used to derive other classes, such that a derived class inherits the properties of the base class and may have added changed members relative to the base class) and all virtual methods (i.e., methods in the base class that are redefined in a derived class) for the APIs offered by the unit 102. The generated virtual methods provide a default implementation of each API for the unit 102, such that the default generated virtual methods may be edited or overridden by a developer. The generated skeleton code includes all the code needed to simulate the unit 102 for the purposes of unit testing. The generated skeleton code forms part of the unit 102 production code (.so file) that is inserted in the UTAF system 100 to perform unit testing on the unit 102, as managed by the UT engine 110.

Since the generated class and APIs of the unit 102 provide a default implementation, the generated skeleton code of the unit 102 is fully functional to simulate the behavior and interactions of the unit 102 for the purpose of testing. Additionally, a developer/programmer may override any of these methods with other generated methods to provide a different implementation and business logic of the unit 102. The unit 102 production code (e.g., the .so file) that is inserted in unit 102 in the UTAF system 100 includes the generated skeleton code (base classes) along with any code implemented by a developer to override the virtual methods. The unit 102 production code may be connected to the UT engine 110 within the UTAF system 100 for unit testing. A unit code generation system may be used to generate the unit production code 102, and an example unit code generation system 200 is shown in FIG. 2, described below.

With reference to FIG. 1, the interfaces 104 may encompass all the interfaces that the unit 102 offers (i.e., for all other units/modules/functions etc. that communicate with the unit being tested). Since the interfaces 104 of a unit 102 may be based on different types of interfaces such as IPC messages, API calls and/or sockets (i.e., endpoints of connections between units/modules), a unit 102 may register its interfaces 104 with the interface registration service 108 to give the unit engine 110 information about each of the interfaces 104, such as the kind of interfaces 104 and the other end of the interfaces 104, for example. Interface registration helps UT engine 110 facilitate communication between the unit 102 being tested and other components in the UTAF system 100. The resource registration service 106 may be included to track and monitor various resources such as sockets/file descriptors, threads, and/or memory. The resource registration service 106 may help in generating statistics on the resources (e.g., memory usage, socket/file descriptor usage, etc.) during the execution of unit testing by the UTAF system 100, which may be used by a developer to optimize the usage of these resources.

The base code of the UTAF system 100 is the UT engine 110. The CLI 112 may provide information to the UT engine 110, which may include, but is not limited to include, any of the following example information: testing commands; logging messages/API calls on a particular interface 104; commands to trigger record/replay of messages; and/or commands to print resource usage of the unit 102 or other component of the UTAF system 100. In an example, the CLI 112 may be a separate piece of software/executable (or any combination of software/hardware) that connects to the UT engine 110 on a predetermined TCP port (not shown). Once connected to UT engine 110, the CLI 112 pushes CLI commands to the UT engine 110 for execution.

The automation component 114 handles record and replay of the messages/API calls of the unit 102. In an example, once enabled via a CLI command from CLI 112, a record command from the automation component 114 puts the unit 102 into recording mode where all interactions (e.g., messages, API calls, etc.) of the UTAF system 100 components on the interfaces 104 of the unit 102 are recorded as a test case into a file (e.g., stored in memory) in the UTAF system 100. For example, the recording may include the name of an API that was called, the values of the input parameters of the call, and/or the values for the output parameters of the call. Many such calls may be recorded as a test case in the same file. The record command may be used in a running system with the unit 102 where external actions are taking place.

Once a recording of a sequence of calls (e.g., a test case) have been recorded to a file, the unit 102 may be brought up by the UT engine 110 in standalone mode and the recording may be fed back to the unit 102 via a replay (play) command from the CLI 112. For example, the automation component 114 may call an API with the same input parameters and assert on the expected output values of the API as described in the recording. If there is a mismatch in the API output of the replay versus the recording, the unit test may be declared as failed.

The unit IPC 120 is responsible for the interface messaging between any two components in the UTAF system 100. The UTAF system 100 enforces a way of communication between the components that are managed by the UT engine 110. The communication between two components in the UTAF system 100 could be based on IPC or function/API calls, and the unit IPC 120 treats IPC or function/API calls in a similar way. In an example, a message has a predefined format thus flows from one component to another. An API call to another component in the UTAF system 100 may also be treated in the same way. For example, the UTAF system 100 may define a specific pattern in which an API call is encoded as a message. For example, an API call func(a,b) may be encoded in a message with the following format, <func><a><b>. Thus, unit IPC 120 is responsible for passing a message/API call from the caller component to the called component in the UTAF system 100.

The environment stubbing component 122 may be responsible for providing environment dependencies to a component in the UTAF system 100. For example, some components of the UTAF system 100 may need specific values of some environment variables or the presence of a file in the UTAF system 100. These dependencies on the environment may be captured in the unit definition file for unit 102 (see FIG. 2 for description of the unit definition file) so that environment stubbing component 122 sets up the environment variables, and provides them to UTAF system 100 components as needed, using the unit definition file when the unit 102 is brought up in standalone mode in the UTAF system 100 for testing.

The logging component 124 is responsible for turning on traces (i.e., the logging of information of a program's execution, for example by recording the information to a file stored in memory) for the components in the UTAF system 100 for which traces are requested or needed. Based on the CLI 112 commands received at UT engine 110, the logging component 124 enables/disables tracing of a particular component. Once test cases have been run in the UTAF system 100 on the unit 102 being tested, the code coverage utility component 118 may determine the percentage of the unit's 102 code that has been covered by completed test cases. For the code coverage to work, the source code of the unit 102 may need to be compiled with specific options on the compiler to capture code coverage data. The debug memory library 116 is run during unit testing in the UTAF system 100, and may capture memory leaks and/or corruption during unit testing. At the end of testing, the debug memory library 116 may generate an output report to indicate if a memory leak or corruption occurred.

FIG. 2 is a high-level system diagram of an example unit code generation system 200 for generating unit code 202 (e.g., unit.so file) for the complete unit being tested from a unit definition file 204 (also called the unit description file 204), in accordance with the disclosures herein. The generated unit code 202 is the code used to run the unit 102 in the UTAF system 100 of FIG. 1. Also, the unit code generation system 200 may be considered part of the UTAF system 100, and may be implemented separately from the other components of the UTAF system 100, or as a component/sub-component of the UTAF system 100.

With reference to FIG. 2, the unit definition file 204 describes all the properties of the unit being tested, and is compiled by a compiler 206 to generate the unit skeleton code 218 (also called the unit skeleton generated code 218). As explained above, the unit definition file 204 may be a text file that describes all the properties of the unit being tested, and may include, but is not limited to include, any of the following information: the unit name; APIs offered by the unit; APIs imported from other units; dependencies on other units; and/or expected states of other units with which the unit being tested communicates. Based on the generated skeleton code 218, developers may implement the APIs and handlers 222 as part of the unit test code 202, and may use supporting UT classes and utilities 224 when implementing the APIs and handlers 222. The compiler 206 may be a separate program/executable that compiles the unit definition file 204 to generate base classes and methods for the unit being tested. The methods/APIs 208 are the interfaces for other units to interact with the unit being tested. For example, the APIs 208 may be based on IPCs (messages) or direct function calls into the unit. The compiler 206 generates a number of CLI handlers 210 (i.e., functions executed in response to CLI events) for the unit test code 202 to exist and function properly for the purpose of unit testing in the context of a UTAF system.

The unit code 202 may include a stubs for other units component 220 that may generate and populate the stubs for all the other units with which the unit interfaces. The unit code 202 may include an APIs component 208 that may generate the APIs to which the unit is exposed. The CLI handlers 210 execute commands (e.g., a command to turn on tracing) from the CLI in the unit testing framework (e.g., from CLI interface 112 in FIG. 1). The system state machine (SSM) handler 212 may resolve dependencies between units, which is needed to bring the unit up in isolation for testing. The automation handler 214 handles executing test cases, such as those run during record and replay. IPC handler 216 handles interface messaging.

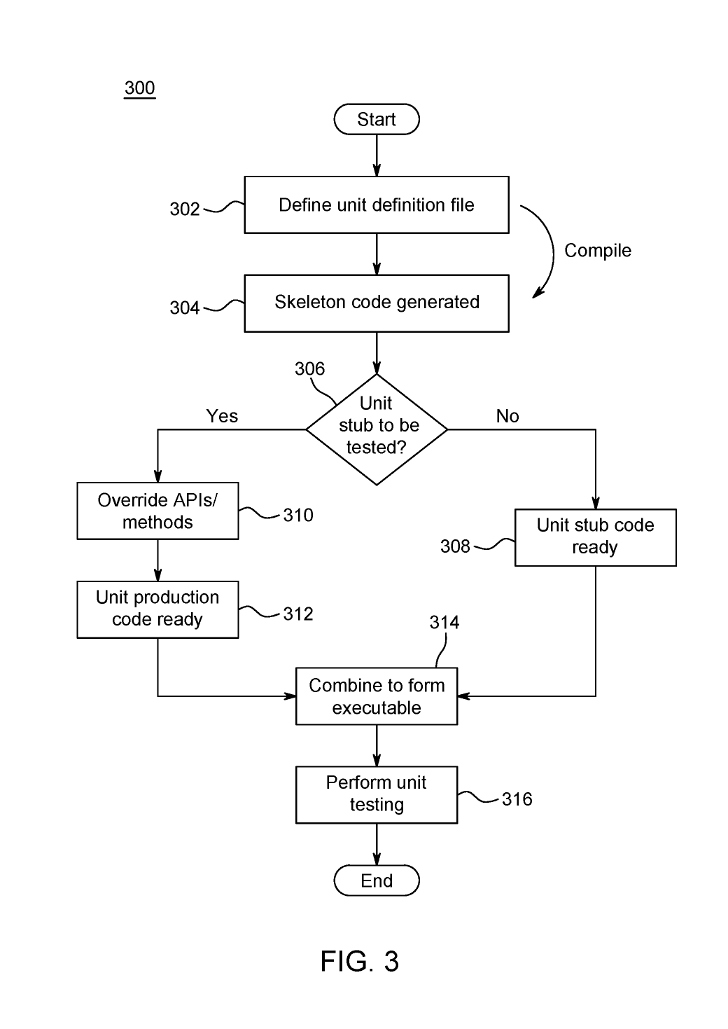

FIG. 3 is a flow diagram of a unit code generation procedure 300, in accordance with the disclosures herein. At 302, a unit definition file is defined that describes all the properties of the unit being tested. At 304, the unit definition file is compiled to generate the skeleton code. At 306, stubs are automatically generated for all the other units with which the unit interfaces, and for each stub generated it is determined if the stub should be maintained for unit testing. If the stub is to be maintained for testing, then at 308, the stub code is added to the unit production code. If the stub needs to be modified for testing (e.g., by modifying parameters being passed to the unit, etc.), then at 310, the APIs/methods may be edited/overridden with replacement code, and, at 312, added to the unit production code. At 314, the stubs are combined to create an executable (e.g., unit production code, .so file) by combining/linking object code of the unit being tested and the plurality of other stub units on which the unit is dependent on. At 316, unit testing may be performed on the unit using the executable, for example by providing the executable to the UTAF system (e.g., UTAF system 100 in FIG. 1).

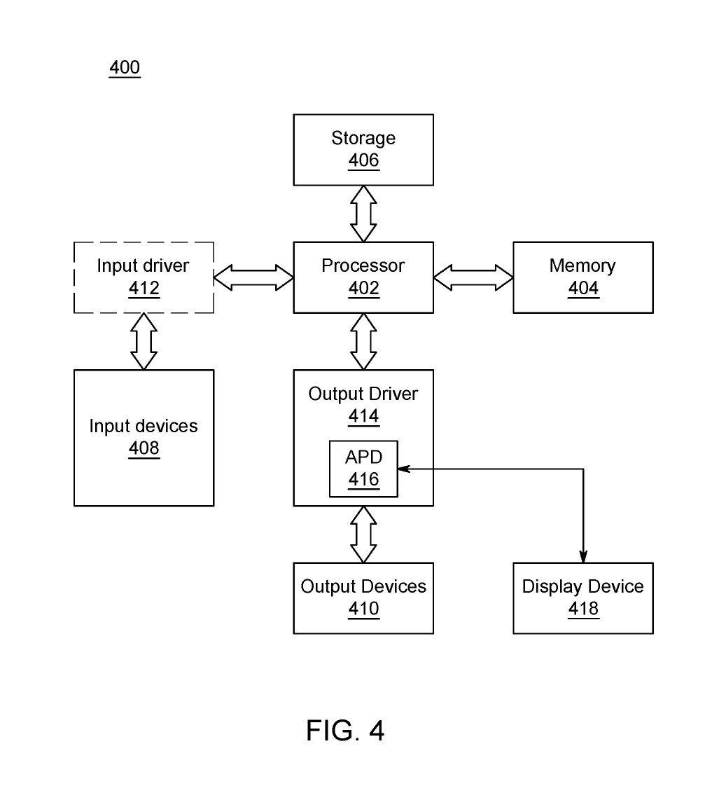

In an example, the UTAF system 100, the unit code generation system 200, the unit code generation procedure 300, and any subset or one or more component(s) thereof, may be implemented using software and/or hardware and may be partially or fully implemented in a computing system, such as the computing system 400 shown in FIG. 4.

FIG. 4 is a block diagram of a computing system 400 in which one or more disclosed embodiments may be implemented. The computing system 400 may include, for example, a computer, a gaming device, a handheld device, a set-top box, a television, a mobile phone, or a tablet computer. The computing system 400 may include a processor 402, a memory 404, a storage 406, one or more input devices 408, and/or one or more output devices 410. The device 400 may include an input driver 412 and/or an output driver 414. The device 400 may include additional components not shown in FIG. 4.

The processor 402 may include a central processing unit (CPU), a graphics processing unit (GPU), a CPU and GPU located on the same die, or one or more processor cores, wherein each processor core may be a CPU or a GPU. The memory 404 may be located on the same die as the processor 402, or may be located separately from the processor 402. The memory 404 may include a volatile or non-volatile memory, for example, random access memory (RAM), dynamic RAM, or a cache.

The storage 406 may include a fixed or removable storage, for example, a hard disk drive, a solid state drive, an optical disk, or a flash drive. The input devices 408 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 410 may include a display, a speaker, a printer, a haptic feedback device, one or more lights, an antenna, or a network connection (e.g., a wireless local area network card for transmission and/or reception of wireless IEEE 802 signals).

The input driver 412 may communicate with the processor 402 and the input devices 408, and may permit the processor 402 to receive input from the input devices 408. The output driver 414 may communicate with the processor 402 and the output devices 410, and may permit the processor 402 to send output to the output devices 410. The output driver 416 may include an accelerated processing device (“APD”) 416 which may be coupled to a display device 418. The APD may be configured to accept compute commands and graphics rendering commands from processor 402, to process those compute and graphics rendering commands, and to provide pixel output to display device 418 for display.

In an example, with reference to FIG. 1, the UT Engine 110, and other components of the UTAF system 100 such as the CLE 112, the automation component 114, and the debug memory library component 116, etc., may be implemented, at least in part, in one or more processors 402 and may access files and stores files and information to memory 404 and/or storage 406 in FIG. 4. In another example, with reference to FIG. 2, the compiler 206 as well as the elements of skeleton code 218 may be implemented, at least in part, in one or more processors 402 and may access and store files (e.g., unit definition file) and information to memory 404 and/or storage 406 in FIG. 4, such that developers may implement APIs/handlers 222 by accessing processor 402 and memory 404 using input devices 408, output devices 410 and/or display device 418 (unit code generation procedure 300 in FIG. 3 may similarly be implemented in computing system 400 of FIG. 4).

It should be understood that many variations are possible based on the disclosure herein. Although features and elements are described above in particular combinations, each feature or element may be used alone without the other features and elements or in various combinations with or without other features and elements.

The methods and elements disclosed herein may be implemented in/as a general purpose computer, a processor, a processing device, or a processor core. Suitable processing devices include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods, flow charts and elements disclosed herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A unit test and automation framework (UTAF) system configured to test a unit in isolation, wherein the unit is a piece of code in a software system that interfaces with a plurality of other units in the software system, the UTAF system comprising:
a compiler configured to compile a unit definition file for the unit to generate a skeleton code for the unit that describes a structure of the unit and interactions of the unit with the plurality of other units, wherein at least one of the interactions of the unit with the plurality of other units is overridden to generate a unit production code for the unit;
a unit testing (UT) engine configured to enable interactions between the unit and the plurality of other units to run test cases on the unit production code to perform unit testing on the unit;
a command line interface (CLI) component configured to provide test commands to the UT engine for running the test cases and displaying statistics about the unit during the running of the test cases;
a unit inter-process communication (IPC) component configured to provide interface messaging between the unit and the plurality of other units to the UT engine;
an automation component configured to provide commands for record and replay testing to the UT engine;
a resource registration service configured to provide information regarding memory resources for the unit during the running of the test cases to the UT engine to debug memory; and
an environment stub component configured to generate and provide stubs for the plurality of other units to the UT engine to be used for the running of the test cases.

2. The UTAF system of claim 1, wherein the unit definition file includes properties of the unit including at least one of: a unit name, dependencies of the unit on the plurality of other units, or expected states of the plurality of other units.

3. The UTAF system of claim 1, wherein the skeleton code for the unit automatically instantiates stubs for the plurality of other units that interact with the unit during run-time operation.

4. The UTAF system of claim 1, wherein the skeleton code for the unit automatically generates sample automation scripts for each application programming interface (API) exposed by the unit during run-time operation.

5. The UTAF system of claim 1, further comprising:
a logging component configured to automatically turn on traces and logging at least one of the plurality of other units.

6. The UTAF system of claim 1, further comprising:
a code coverage utility component configured to determine a percentage of code of the unit that has been tested by the running of the test cases by the UT engine.

7. The UTAF system of claim 1, further comprising:
a debug memory library configured to capture and report memory leaks and corruption during the unit testing on the unit.

8. The UTAF system of claim 1, wherein the skeleton code includes at least one of: application programming interfaces (APIs) for the plurality of other units, CLI handlers, a system state machine (SSM) handler, an automation handler, an IPC handler, or stubs for the plurality of other units.

9. The UTAF system of claim 1, further comprising:
an interface registration service configured to register interfaces of the unit with the UT engine.

10. The UTAF system of claim 1 implemented as part of a computing system.

11. A method for unit testing a unit in isolation, performed by a unit test and automation framework (UTAF) system, wherein the unit is a piece of code in a software system that interfaces with a plurality of other units in the software system, the method comprising:
compiling a unit definition file for the unit to generate a skeleton code for the unit that describes a structure of the unit and interactions of the unit with the plurality of other units, wherein at least one of the interactions of the unit with the plurality of other units is overridden to generate a unit production code for the unit;
enabling interactions between the unit and the plurality of other units to run test cases on the unit production code to perform unit testing on the unit;
providing test commands for running the test cases and displaying statistics about the unit during the running of the test cases;
providing interface messaging between the unit and the plurality of other units;
providing commands for record and replay testing;
providing information regarding memory resources for the unit during the running of the test cases to debug memory; and
generating and providing stubs for the plurality of other units to be used for the running of the test cases.

12. The method of claim 11, wherein the unit definition file includes properties of the unit including at least one of: a unit name, dependencies of the unit on the plurality of other units, or expected states of the plurality of other units.

13. The method of claim 11, wherein the skeleton code for the unit automatically instantiates stubs for other units that interact with the unit during run-time operation.

14. The method of claim 11, wherein the skeleton code for the unit automatically generates sample automation scripts for each application programming interface (API) exposed by the unit during run-time operation.

15. The method of claim 11, further comprising:
automatically turning on traces and logging at least one of the plurality of other units.

16. The method of claim 11, further comprising:
determining a percentage of code of the unit that has been tested by the running of the test cases.

17. The method of claim 11, further comprising:
capturing and reporting memory leaks and corruption during the unit testing on the unit.

18. The method of claim 11, wherein the skeleton code includes at least one of: application programming interfaces (APIs) for the plurality of other units, CLI handlers, a system state machine (SSM) handler, an automation handler, an IPC handler, or stubs for the plurality of other units.

19. The method of claim 11, further comprising:
registering interfaces of the unit.

20. The method of claim 11 implemented as part of a computing system.
